(19) United States
(12) Patent Application Publication
(10) Pub. No.: US 2014/0258207 A1
(43) Pub. Date: Sep. 11, 2014

(54) Systems and Methods for Predicting Protein-Ligand Interactions

(71) Applicant: The Trustees of Columbia University in the City of New York, New York, NY (US)

(72) Inventors: Donald Petrey, New York, NY (US); Barry Honig, New York, NY (US); Fabian Dey, New York, NY (US)

(73) Assignee: The Trustees of Columbia University in the City of New York, New York, NY (US)

(21) Appl. No.: 14/201,311

(22) Filed: Mar. 7, 2014

Related U.S. Application Data
(60) Provisional application No. 61/774,470, filed on Mar. 7, 2013.

(51) Int. Cl. G06N 5/04; G06F 19/24

(52) U.S. Cl. CPC G06N 5/04; G06F 19/24
USPC 706/50; 706/46

(57) ABSTRACT

Systems and methods for predicting protein-ligand interactions are disclosed. An exemplary method can include identifying a set of structural neighbours of the query proteins, where each of contains ligands. The method can also determine a similarity score for each of the structural neighbours representing configuration similarity and interaction tendency between the structural neighbours and predict protein-ligand interactions of the one or more query proteins using the similarity scores.

### CROSS-REFERENCE TO RELATED APPLICATION

This application claims priority from U.S. Provisional Application Ser. No. 61/774,470, filed Mar. 7, 2013, the disclosure of which is incorporated by reference herein.

### STATEMENT REGARDING FEDERALLY-SPONSORED RESEARCH

This invention is made with government support under National Institute of Health grant nos. GM030518 and U54-GM94597. The Government has certain rights in the invention.

### BACKGROUND

The disclosed subject matter broadly relates to systems and methods for predicting protein-ligand interactions.

Certain approaches to predict of small molecule binding sites can depend upon the unique characteristics of the sites compared to the rest of the protein surface. For example, approaches to prediction of small molecule binding sites can utilize the fact that ligands can bind to the largest surface pocket on a protein or that such binding sites are likely to be evolutionarily conserved since they are functionally constrained.

Other approaches to predict of small molecule binding sites can depend upon the detection of similarities between binding pockets based a variety of representations that can depend on their geometric, biophysical or sequence properties. In some approaches to predict of small molecule binding sites, the surface of a protein with an unknown ligand can be scanned for likely ligand binding sites by either directly examining the properties of the surface or comparing the surface to a database of known binding pockets.

Certain approaches can use measures of the structural similarity of a given query protein to other proteins with a known ligand. However, these approaches can rely on the availability of experimentally determined protein structures in their ligand-bound form and this information that may not be available. An improved approach is needed to predict ligand interactions.

### SUMMARY

Systems and methods for predicting protein-ligand interactions are disclosed herein.

In one aspect of the disclosed subject matter, techniques for predicting protein-ligand interactions for one or more query proteins are disclosed. An exemplary method can include identifying a set of structural neighbours of the one or more query proteins, where each contains ligands. The method can also determine a similarity score for each of the structural neighbours representing configuration similarity and interaction tendency between the structural neighbours and predict protein-ligand interactions of the one or more query proteins using the similarity scores.

In some embodiments, the database can include ligand-binding residues of one or more proteins. In other embodiments, the database can include at least one structure of the one or more proteins in its holo form. In an embodiment, the database can include at least one structure of the one or more proteins in its apo form.

In some embodiments, the determination of the similarity score includes placing ligands from the set of structural neighbours in a coordinate system of the query proteins using a transformation. The transformation relates the structural neighbours to the query proteins and creates a transformed ligand. In one embodiment, the method further determines whether the transformed ligand is within a predetermined distance of the surface residue of the query proteins. If the transformed ligand is within a predetermined distance of the surface residue of the query proteins, a counter is incremented. This counter is used to determine the similarity score of the structural neighbour.

In some embodiments, the surface residue can include greater than a predetermined solvent accessible surface area.

In some embodiments, the method can further includes identifying any interactions the ligands of the structural neighbours makes with the structural neighbour and interactions the transformed ligands makes in the coordinate system of the query proteins.

In some embodiments, the method can further include optimizing the set of one or more structural neighbours. This can include compiling a reference set of ligands associated protein chains from the database, identifying a chain to which the ligands are bound by using a predetermined distance cutoff, and clustering proteins associated with the ligands into one or more non-redundant groups based on the predetermined distance cutoff. For each of the one or more non-redundant groups, the associated proteins can be sorted based on classification and fold level. The classification and fold level that have a sequence identity more than a predetermined percentage value to other proteins are discarded.

In one aspect of the disclosed subject matter, computer-readable storage media having instructions for predicting protein-ligand interactions for one or more query proteins are disclosed. In one embodiment, the computer-readable storage media has instructions that cause the computer to display a graphical user interface component that can receive query proteins and structural neighbours. The instructions can then cause the processor to determine a similarity score for each of the structural neighbours. The instructions can then display a second graphical user interface component that provides the prediction of the protein-ligand interactions of the query protein.

In another aspect of the disclosed subject matter, a system for predicting the protein-ligand interactions for the query proteins is disclosed. In one embodiment, the system comprises a database. The database contains a set of structural neighbours of the query proteins. The system further comprises an input component that can receive the structural neighbour and the query proteins. The system also comprises a processor to determine and generate a similarity score and an output component that can display the prediction of the protein-ligand interactions of the query proteins using the similarity score.

### BRIEF DESCRIPTION OF THE DRAWINGS

FIG. 1 illustrates a block diagram of an exemplary embodiment of a system that can be used to predict of small molecule binding sites in accordance with the disclosed subject matter.

FIG. 2 is a flow chart that illustrates an exemplary method to predict protein-ligand interactions for one or more query proteins in accordance with the disclosed subject matter.

FIG. 3 is a flow chart that illustrates an exemplary method to determine the similarity score for each structural neighbour in accordance with the disclosed subject matter.

FIG. 4A, FIG. 4B, FIG. 4C, and FIG. 4D illustrate the exemplary method described in the disclosed systems and methods in accordance with the disclosed subject matter.

FIG. 5 is a flow chart that illustrates an exemplary method to optimize the database that can contain one or more the ligands associated protein chains in accordance with the disclosed subject matter.

FIG. 6A FIG. 6B, FIG. 6C, and FIG. 6D illustrate an exemplary the binding site similarity and prediction using the exemplary method disclosed in the disclosed systems and methods.

FIG. 7A and FIG. 7B illustrate exemplary analysis of the conservation of ligand binding sites.

FIG. 8 illustrates an exemplary binding site prediction recall and precision in accordance with the disclosed systems and methods.

FIG. 9A, FIG. 9B, and FIG. 9C illustrate exemplary correlation between binding site similarity and ligand shape in accordance with the disclosed systems and methods.

FIG. 10A and FIG. 10B illustrate an exemplary global binding site similarity between two proteins with a different SCOP fold classification but similar binding site in accordance with the disclosed systems and methods.

FIG. 11A, FIG. 11B, FIG. 11C, FIG. 11D, FIG. 11E, and FIG. 11F illustrate an exemplary dependence of binding site similarity with other measures of structural and sequence similarity in accordance with the disclosed systems and methods.

FIG. 12A, FIG. 12B, FIG. 12C, and FIG. 12D illustrate exemplary binding site prediction in accordance with the disclosed systems and methods.

### DETAILED DESCRIPTION

Systems and methods for predicting protein-ligand interactions and predict ligand binding sites in proteins are presented. An exemplary method includes obtaining a query protein, and identifying one or more structural neighbors of the query protein which have at least one known ligand, e.g., a ligand that has been previously associated with the identified structural neighbor. In one embodiment, structural alignment is used to identify the structural neighbors of the query protein. For each query protein, ligands from the identified structural neighbors are iteratively placed in the coordinate system of the query protein, e.g., using a transformation that relates the structural neighbor to the query. A similarity score can be calculated that reflects whether the pattern of interactions the ligand makes with its native partner also occur with the query, to thus identify the ligand binding sites of the query protein.

The systems and methods described herein can detect ligand binding sites and provide information about the nature of the ligand that binds to a particular site, even when the prediction is based on pairs of proteins that share only a remote structural relationship, i.e., they belong to different functional or structural families. Accordingly, they can be used in a various aspects of drug discovery, including drug re-purposing, identification of protein-protein interface inhibitors, and the identification of off-target proteins that can lead to drug side-effects.

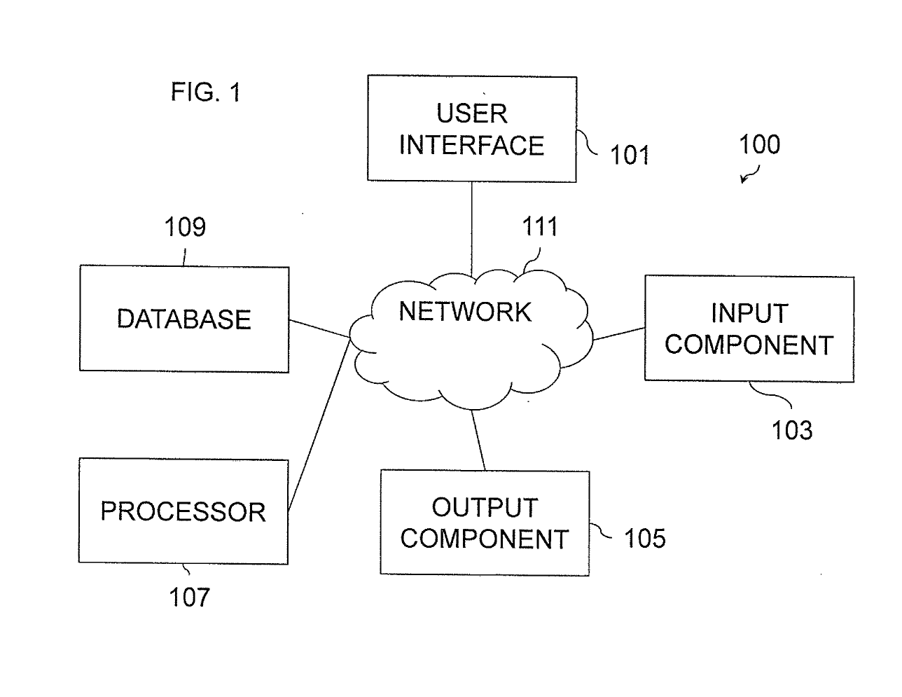

FIG. 1 illustrates a block diagram of an exemplary embodiment of a system 100 that can be used to predict of small molecule binding sites. The depicted embodiment comprises a user interface 101, an input component 103, an output component 105, a processor 107, a database 109, and network 111. It should be understood that the system 100 can include one or more databases 109, one or more processors 107, one or more output components 105, one or more input components 103, and one or more user interfaces 101.

For purposes of this disclosure, the database 109 and the system 100 can include random access memory (RAM), storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory. The processor 107 can include processing logic configured to carry out the functions, techniques, and processing tasks associated with the disclosed subject matter. Additional components of the database 109 can include one or more disk drives. The system 100 can include one or more network ports for communication with external devices. The input component 103 can include a keyboard, mouse, other input devices, or the like. An output component 105 can include a video display, a cell phone, other output devices, or the like. The network 111 can include communications media such wires, optical fibers, microwaves, radio waves, and other electromagnetic and/or optical carriers; and/or any combination of the foregoing.

In some embodiments, the database 109 can include ligand-binding residues of one or more proteins. In other embodiments, the database can include at least one structure of the one or more proteins in its holo form. In an embodiment, the database can include at least one structure of the one or more proteins in its apo form. In certain embodiments, the output component 105 can be used in conjunction with the user interface 101. The user interface 101 can be configured to receive input data, for example the query protein, from the input component 103. The user interface 101 can be configured to display output data, for example the similarity score or prediction of small molecule binding sites to the output component 105. In some embodiments that use one or more computers, the computers can be coupled together by one or more network, such as the network 111.

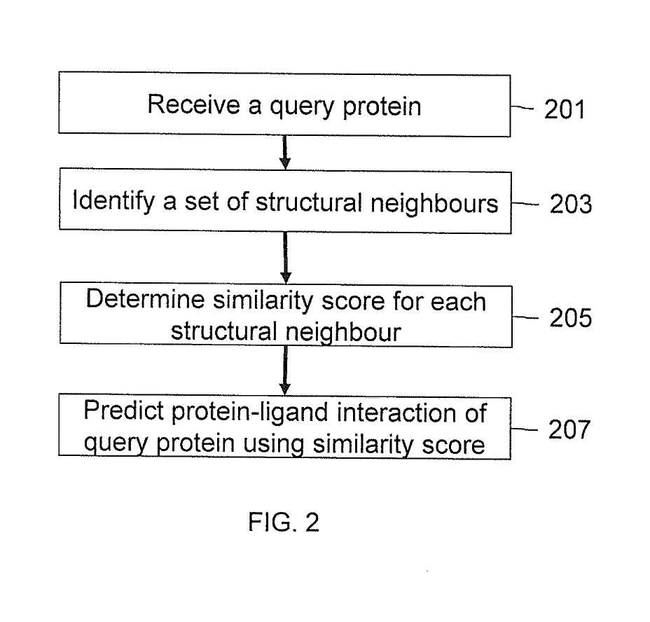

For purpose of illustration and not limitation, exemplary method of the disclosed subject matter will now be described. FIG. 2 is a flow chart that illustrates an exemplary method to predict protein-ligand interactions for one or more query proteins 401. In a method, a query protein 401 is received (201), for example, from an input component 103. In further embodiments, a set of structural neighbours 403 are identified (203) from the database 109, for example, using a processor 107. The database 109 can contain one or more ligands associated protein chains and ligand-binding residues of one or more proteins. The database 109 can contain protein structures in their holo form or their apo form. A similarity score is then determined for each structural neighbour 403 (205). This can be done, for example, using a processor 107. The similarity score is then used to predict the protein-ligand interaction of each query protein 401 (207). The similarity score and the prediction can be outputted to the user using the output component 105.

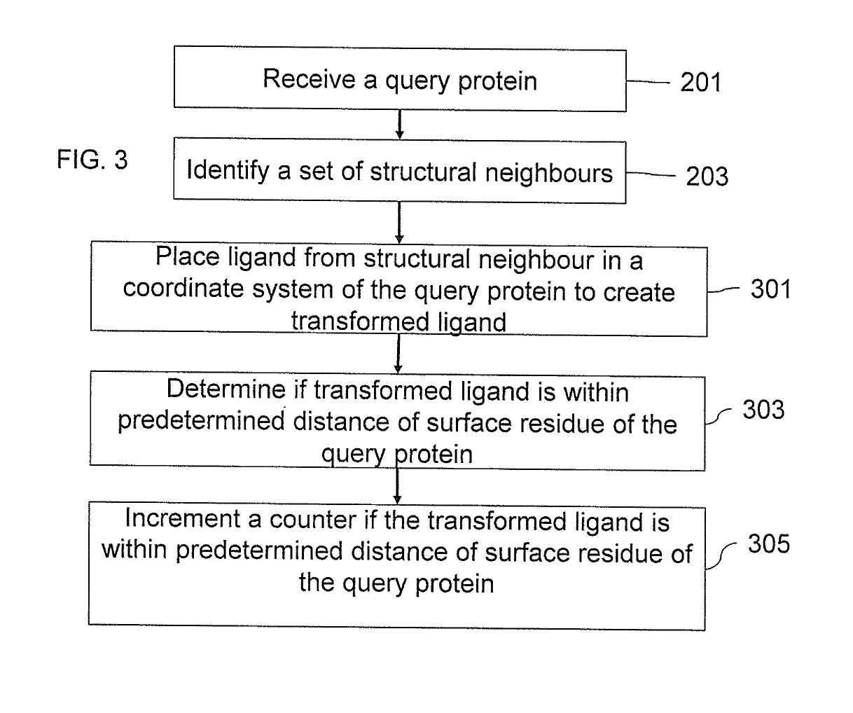

FIG. 3 is a flow chart that illustrates an exemplary method to determine the similarity score for each structural neighbour (205). In a method, a query protein 401 is received (201), for example, from an input component 103. In further embodiments, a set of structural neighbours 403 are identified (203) from the database 109, for example, using a processor 107. Each structural neighbour 403 that is identified can be placed in a coordinate system of the query protein 401 (301). This can create a transformed ligand 407.

In one example, the method determines whether the transformed ligand 407 is within a predetermined distance of surface residue of the query protein (303). In one example, surface residues can be taken to be those with greater than a predetermined solvent accessible surface area. If the transformed ligand 407 is within the predetermined distance of surface residue of the query protein 401, a counter can be incremented (305). The counter can be, for example, only incremented once for each structural neighbor 403 even if multiple ligands 405 from that neighbor 403 are in the vicinity of the residue.

In one example, a z-score can be calculated. In one example, the similarity score can be determined using a z-score. The z-score calculated can reflect whether there is a set of residues on the surface that are associated with a significantly increased set of contacting frequencies, as compared to frequencies generated by random selection of surface residues. In anther example, the similarity score can be calculated using:

$$\begin{matrix}{S}_{QN} = {\sum }_{v}^{{n}_{Q}} {\sum }_{w}^{{n}_{N}} {m}_{vw} \text{?} & Equation ( 1 ) \\ Sim ( Q , N ) = \frac{{S}_{QN}}{max ( {S}_{QQ} , {S}_{NN} )} = [ 0 , 1 ] \\ \text{?} \text{indicates text missing or illegible when filed} & Equation ( 2 )\end{matrix}$$

Where r_{νw} is the distance from an atom of query protein 401 Q interacting with the ligand 405 and an atom from structural neighbor 403 N interacting with the ligand 405, m_{νw} is a matching index (which can be equal to 1 if the atoms are involved in at least one identical interaction 0 otherwise), and r is a scaling factor of 0.7. This exemplary method can be repeated for each structural neighbor 403 of the query protein 401 and the predicted binding site (207) can be determined by, for example, the set of residues with the highest sum of similarity scores, with the squared similarities giving more weight to high-scoring binding sites.

In another example, random frequencies can be determined to create random surface patches with the same number of ligand-contacting atoms as in the native complex. The similarity score can, for example, reflect whether atoms in the query protein 401 have a similar configuration and would form similar interactions to atoms in the structural neighbor 403 that interact with the ligand 405.

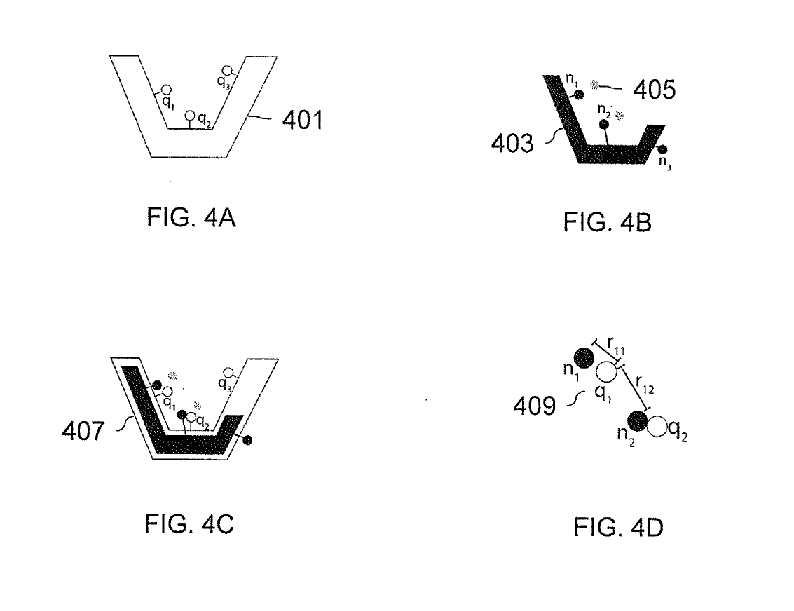

FIG. 4A, FIG. 4B, FIG. 4C, and FIG. 4D illustrate the exemplary method described in the disclosed systems and methods. FIG. 4A illustrates an exemplary query protein 401 (201). The query protein 401 can have atoms, such as q1, q2, and q3 illustrated in FIG. 4A. FIG. 4B illustrates an exemplary ligand-containing protein 403, that can be a structural neighbor of the query protein 401 (203). The exemplary ligand 405 can bind to the ligand-containing protein 403. The ligand contacting residues of the protein 403 can also be identified. FIG. 4C illustrates a transformed ligand 407 that is created when the ligand-containing protein 403 is placed on the coordinate system of the query protein 401 (301). A similarity score can then be determined (205). The similarity score can be determined, for example, by calculating the distance r₁₁ and r₁₂ between the atoms of the query protein 401 interacting with the ligand and the atoms of the structural neighbor 403 that interacts with the ligand, as further illustrated in FIG. 4D.

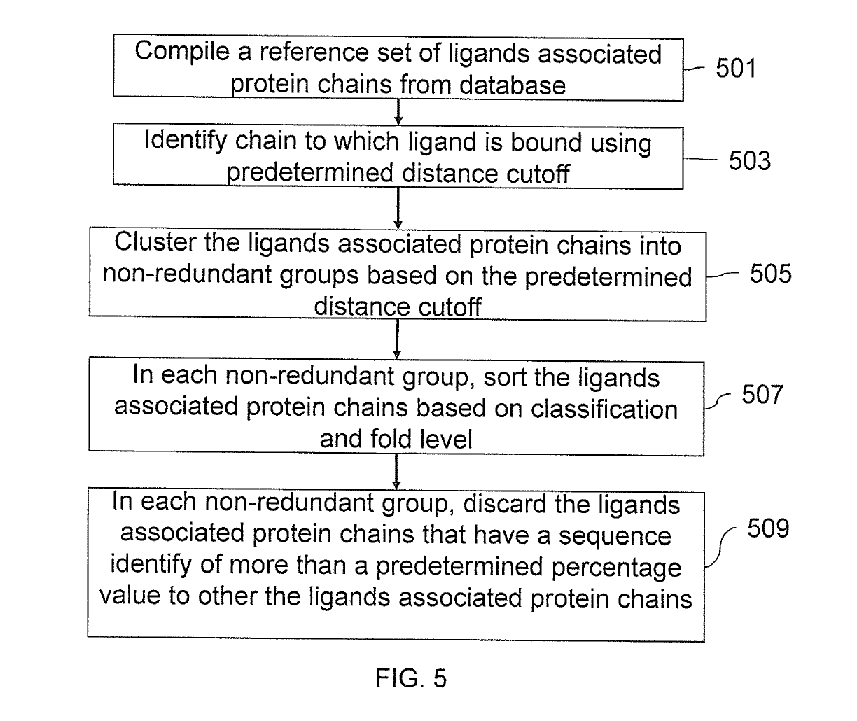

FIG. 5 is a flow chart that illustrates an exemplary method to optimize the database 109 that can contain ligands associated protein chains 402. It should be understood that this exemplary method can be used to optimize database 109 containing other data as well. A reference set of one or more ligands associated protein chains can be compiled from the database 109 (501). This can be done, for example, using a processor. The chain to which the ligand 405 is bound can be identified using a predetermined distance cutoff value (503).

In one embodiment, based on this cutoff value, the ligands associated protein chains can be clustered into non-redundant groups (505). Each non-redundant group can then be further optimized by sorting out the ligands associated protein chains in each group by, for example, classification and fold level (507). It should be understood that each group can be sorted out using other factors.

For example, the first ligands associated protein chains in the list can be used as the first cluster representative of the group. Subsequent ligands associated protein chains in the group can be discarded, for example, if they had a predetermined sequence identity or a ligand 405 similarity based on a fingerprint of real-valued molecular descriptors above a predetermined value to any ligand 405 of the protein to which that ligands associated protein chains is compared. In each group, the ligands associated protein chains that have a sequence identify of more than a predetermined percentage value to other ligands associated protein chains can be discarded from the group (509).

The disclosed exemplary systems and methods illustrate a technique to detect binding sites based on ligand 405 binding properties of structural neighbors 403 by exploring the use of structural relationships between proteins to predict function. This can occur, for example, because the extent to which the geometric location of ligand binding sites is conserved in sets of structurally similar proteins.

The exemplary systems and methods illustrate that the geometric locations of protein-ligand binding sites can be well-conserved in sets of proteins whose structures are either globally or locally similar. The exemplary systems and methods illustrate that a database, such as the well-known Protein Data Bank (PDB), can be populated with ligand-interacting proteins to enable the prediction of the location of ligand binding sites in general. Moreover, the exemplary systems and methods illustrate that close sequence neighbors is not necessary for accurate predictions. There can be significant conservation of binding site locations even among remote structural homologs.

An exemplary method can use a well-known ligand binding site analysis (LBias), which can exploit global structural similarity combined with local similarity in the configuration of ligand binding residues. This can effectively be used to predict ligand binding sites. In one exemplary embodiment, the exemplary methods can first identify structural neighbors 403 of the query protein 401 that contains a ligand 405 and iteratively places these ligands 405 in the coordinate system of the query protein 403, 407. A similarity score can then be calculated that reflects, for example, whether the pattern of interactions the ligand 405 makes with its native partner or structural neighbor 403 could also occur with the query protein 401. The exemplary methods binding site similarity score can, in addition, be used to infer information about ligand shape, even when the global protein structural similarity used to deduce ligand properties is remote.

The ability of the exemplary methods to detect binding sites can compare favorably with traditional binding pocket detection approaches and, moreover, provide information about the nature of the ligand that binds to a particular site, even when the prediction is based on pairs of proteins that share only a remote structural relationship, i.e., they belong to different functional or structural families. The disclosed methods and system can be used in applications such as drug design, especially in the potential identification of off-target proteins, or the like.

### EXAMPLES

### Example 1

### Query Protein Sets

In an example, Geometric conservation and binding site prediction is evaluated using the well-known LigASite database, which contains the ligand-binding residues for 337 proteins. In this example, the protein with PDB code 2DPO can be ignored if it had been removed from the PDB. The database is non-redundant with each pair of proteins having less than 25% sequence identity. In this example, SCOP definitions can be available for 238 of these proteins, representing a diverse set of 143 folds, 177 superfamilies and 244 families.

For each of the proteins there can be a structure in the PDB co-crystallized with its associated ligand (holo form) and at least one structure of the same protein in its apo form. The Ligand contacting residues in the LigASite database can be identified from the holo forms of the proteins with the well-known program LPC and transferred to the equivalent residues in the apo forms. In order to benchmark the prediction of the binding sites by the disclosed exemplary methods, only the apo proteins in LigASite are used to predict binding. It should be understood that in an example embodiment hobo proteins can be used as well to predict binding.

In this example, two other protein data sets, such as the orphan set and the unknown function set, can be used. For example, the orphan set of query proteins can correspond to proteins whose ligand binding properties cannot be inferred from sequence relationships and are compiled by extracting singleton sequences from the well-known Systers database that have associated structures in the PDB based on their Uniprot annotations. The unknown function set, for example, can be compiled from proteins in the Protein Structure Initiative Structural Genomics Knowledgebase, which is not necessarily annotated. Both of these protein data sets can be clustered at 25% sequence identity with PISCES yielding 48 proteins for the orphan set and 295 for the unknown function set.

### Example 2

### Conservation of Binding Site Location

In an example, an exemplary method illustrated in the disclosed systems and methods to calculate the statistical significance of conservation of the location of binding sites is used. For each query protein 401, ligands 405 from its structural neighbors 403 is iteratively placed in the coordinate system of the query protein 401 using the transformation 407 that relates the structural neighbor 403 to the query 401 (See FIG. 3, 301).

Whenever a transformed ligand 407 from the structural neighbor 403 is within 5 Å heavy atom distance of a surface residue of the query protein 401, a counter associated with that residue is incremented by one (303, 305). The surface residue can be taken to be those with greater than 10 Å² solvent accessible surface area. In this example, the counter associated with each residue is only incremented once for each structural neighbor 403 even if multiple ligands 405 from that neighbor 403 are in the vicinity of the residue. The z-score calculated can reflect whether there is a set of residues on the surface that are associated with a significantly increased set of contacting frequencies, as compared to frequencies generated by random selection of surface residues. In this example, random frequencies are derived using well-known MODELLER program to create random surface patches with the same number of ligand-contacting atoms as in the native complex.

### Example 3

### Binding Site Similarity and Prediction

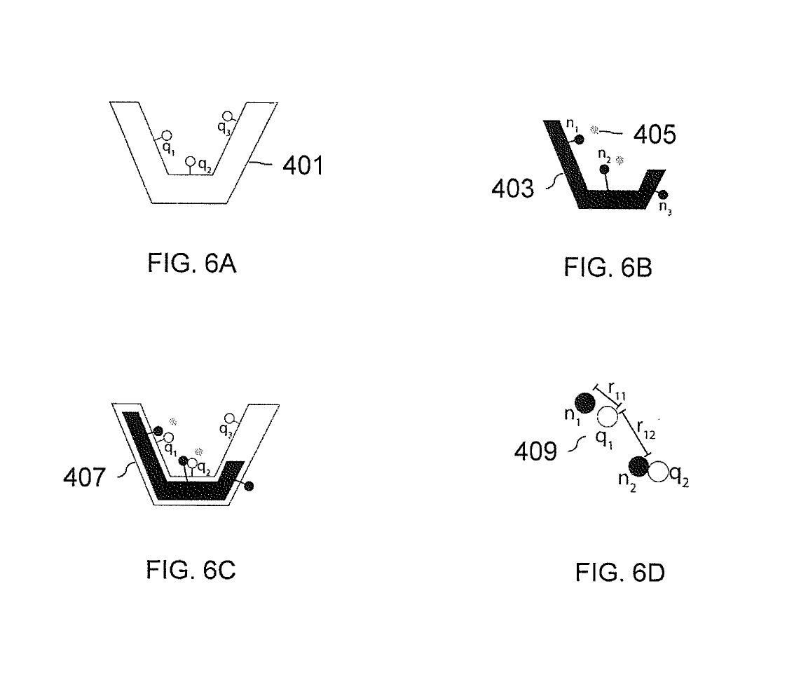

FIG. 6A FIG. 6B, FIG. 6C, and FIG. 6D illustrate an exemplary the binding site similarity and prediction using the exemplary method disclosed in the disclosed systems and methods. FIG. 6A illustrates an exemplary query protein 401 Q with three atoms, q₆, q₂ and q₃, identified specifically. FIG. 6B illustrates an exemplary ligand-containing protein 403 N, a structural neighbor 403 of Q with the exemplary ligand 405 shown as a gray line connecting two gray atoms.

As further illustrated in FIG. 6B, Ligand contacting residues, n₁ and n₂, can be identified. FIG. 6C illustrates that the ligand-containing protein 403 N along with its ligand can be placed in the coordinate system of the query protein 401 Q by applying the geometric transformation that relates the ligand-containing protein 403 N to the query protein 401 Q (301). Thus, for the query protein 401 (Q) and structural neighbor 403 (N), both the structural neighbor 403 and its associated ligand 405 can be placed in the coordinate system of the query protein 401, using the transformation that relates query protein 401 Q to structural neighbor 403 N (301). Residues from query protein 401 Q that interact with the transformed ligand 407 can be identified (for example, q₁ and q₂ of the exemplary query protein 401).

In this example, a similarity score between the binding sites of query protein 401 Q and structural neighbor 403 N, S_{QN} (Sim(Q,N)), is then calculated (205). S_{QN} is a function of all the pairwise distances (e.g., r₁₁, r₁₂) between the atoms from query protein 401 Q interacting with the ligand 405 and the atoms from structural neighbor 403 N interacting with the ligand 405 if the two atoms in question make chemically similar contacts with the ligand 405 (303).

If n₁ makes a hydrogen bond with the ligand 405, but q₁ is hydrophobic, m₁₁ would be zero and there would be no contribution to S_{QN} from this pair of atoms. It should be understood that it is not necessary to define structurally equivalent residues to calculate the similarity since weighting by the exponential ensures that only pairs of atoms that are close in space contribute significantly. In this example, the similarity score, Sim(Q,N), reflects whether atoms in the query protein have a similar configuration and would form similar interactions to atoms in the structural neighbor that interact with the ligand.

For example, Hydrogens are added to all proteins and titratable groups are protonated according to a pH of 7 assuming standard pKas and using heuristic rules from the well-known OpenBabel Package based on atom connectivity. In this example, the interactions the ligand 405 makes in its native binding partner 403 and the interactions that the transformed ligand 407 makes in the context of the query protein 401 structure is identified.

In this example, potential interactions between atoms τ of a ligand 405 and atoms j of a protein query 401 are identified and include, for example, hydrogen bonds (the distance rᵢⱼ≦3.5 Å and <120° angle), aromatic interactions (rᵢⱼ≦5 Å distance), ion pairs (rᵢⱼ≦5 Å distance) and van der Waals contacts (rᵢⱼ≦1.2*Σr_{νdw}), where Σr_{νdw} is the sum of the van der Waals radii for that pair of atoms, taken from the OpenBabel parameter set. The Ligand atoms clashing with protein atoms (rᵢⱼ≦0.5*Σr_{νdw}) are ignored in this example. Hydrogen positions used to determine hydrogen bonding geometries (heavy atom acceptor-donor hydrogen-heavy atom donor angle) are obtained by OpenBabel and the angle criterion are ignored for atoms bonded only to a single heavy atom neighbor (e.g. hydroxyl groups with less certain geometry).

In this example, the similarity in the binding sites between query protein 401 Q and structural neighbor 403 N are calculated by:

$$\begin{matrix}{S}_{QN} = {\sum }_{v}^{{n}_{Q}} {\sum }_{w}^{{n}_{N}} {m}_{vw} \text{?} & Equation ( 3 ) \\ Sim ( Q , N ) = \frac{{S}_{QN}}{max ( {S}_{QQ} , {S}_{NN} )} = [ 0 , 1 ] \\ \text{?} \text{indicates text missing or illegible when filed} & Equation ( 4 )\end{matrix}$$

Where r_{νw} is the distance from an atom of query protein 401 Q interacting with the ligand and an atom from structural neighbor 403 N interacting with the ligand, m_{νw} is a matching index (which can be equal to 1 if these atoms are involved in at least one identical interaction 0 otherwise), and ν is a scaling factor of 0.7.

In this example, Sim(Q,N) can equal 1 in the case of identical interactions and thus equivalent binding sites in both proteins with respect to a single ligand. It should be understood that this function can be independent of the identity of residues in the binding site and can reflect only whether or not similar types of interactions are being formed at roughly equivalent positions in space in the query and structural neighbor. The increased frequency of van der Waals contacts over the other interaction types can have the effect that binding sites are scored highly when they match in shape.

To predict a binding site, a counter associated with each query residue can be incremented by Sim(Q,Nᵢ)² if that residue interacts with the transformed ligand 407 from the neighbor (305). This process is repeated for each structural neighbor 405 of the query protein 403 and the predicted binding site is taken to be the set of residues with the highest sum of similarity scores, with the squared similarities giving more weight to high-scoring binding sites. It should be understood that it is not necessary to identify structurally equivalent ligand-contacting residues in order to calculate Sim(Q,N) although the method can still be applied if an alignment is available.

### Example 4

### Structural Neighbors and Ligands

In this example, a reference set of ligand associated protein chains 403 from the database that contains, for example, PDB can be compiled (501). Any chain in a PDB file (both ATOM and HETATM records in the PDB file) that is, for example, non-covalently bound to a protein and had a molecular weight between 200 and 1000 Daltons are considered a ligand. A program can be developed based on the OpenBabel Package (for example version 2.2 of the package) that can apply these criteria, allow for the potential of peptides as ligands, and eliminate small molecules used in crystallization. When multiple chains are present in a structure, a 5 Å heavy atom distance cutoff is used to identify the chain to which the ligand was bound (503). For protein structures 403 with a domain definition available in SCOP (for example version 1.75), the analysis on a chain level is replaced by SCOP domains.

In this example, to remove redundancy in the set of protein-ligand pairs 403, the set is clustered into non-redundant groups (505). For every query protein 401 in the LigASite dataset, SCOP classifications on the family level are retrieved where available. Sequences of SCOP domains in contact with a ligand are added to a list associated with each query if they are from the same SCOP fold as the query protein 401 and then these sequences are sorted by decreasing similarity according to SCOP classification up to the fold level (507). The first domain in the list is used as the first cluster representative.

Subsequent domains can be discarded, for example, if they had a sequence identity above 60% to any other previously found protein and a ligand Tanimoto similarity based on a fingerprint of real-valued molecular descriptors above 0.6 to any ligand of the protein to which that domain was compared (509). It should be understood that the Tanimoto similarity is one way to determine similarity measure in chemical structures. Domains are retained as a new cluster center if either of the latter two criteria are not satisfied. In this example, the resulting optimized pool of structural neighbors 403 can come at an additional computational cost but can result in a favorable binding site prediction performance.

In another example, redundancy can be eliminated in a set of protein-ligand pairs in a manner that ignores ligand shape by, for example, clustering the proteins using a 60% sequence identify cutoff. This is achieved by using the well-known program CD-HIT v. 3.1.1. Structural neighbors 403 are selected from this pool using a protein structural distance (PSD) cutoff of 0.8. This can be achieve using a program such as Combinattorial Extension (CE), DALI, and MAMMOTH, or the like. This approach can reduce the diversity of ligands 405 in the pool of structural neighbors 403 since the same or highly similar proteins can be co-crystalized with different ligands 405.

In this example, to analyze the relationship between binding site similarity and ligand 405 shape as measured by Tanimoto similarity, a set of query proteins 401 are compiled by clustering the SCOP 1.75 database at 40% sequence identity, and select representatives of each cluster containing a ligand 405. The structural neighbors 403 are selected from the 60% non-redundant pool resulting in protein pairs, with each containing a ligand 405. The Tanimoto similarity of respective ligands can be calculated based on a set of descriptors described in the supplemental material of reference.

### Conservation of Ligand Binding Sites

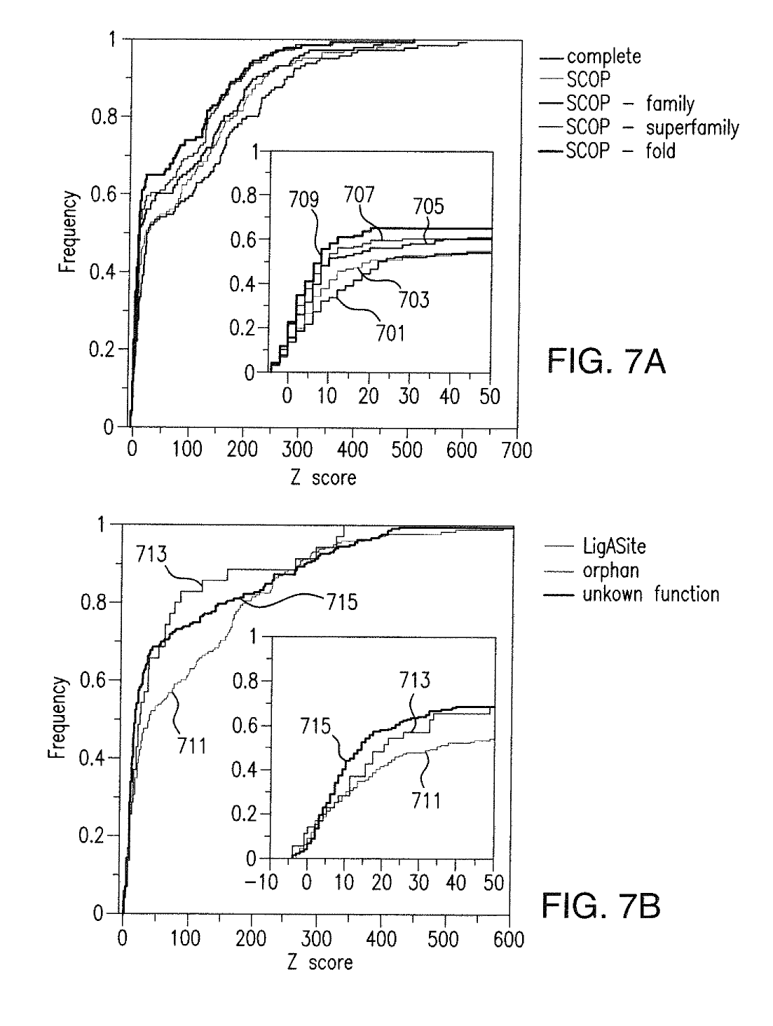

FIG. 7A and FIG. 7B illustrate exemplary analysis of the conservation of ligand binding sites. In this exemplary analysis, the calculated z-score reflects the conservation of the geometric location of ligand binding sites among a set of structural neighbors 403 of a given query protein 401. In this example, the query proteins 401 were taken from LigASite. FIG. 7A illustrates cumulative histogram of z-scores for apo proteins, where each line corresponds to the selection of structural neighbors from different pools with increasingly remote structural similarity.

For the results, z-scores were calculated only for 146 proteins that had more than or equal to 5 neighbors 403 selected from every pool used. FIG. 7A illustrates a line 701 that was obtained using all structural neighbors 405. The remaining curves illustrated in FIG. 7A were obtained from the former by first including only neighbors 405 which were defined at the fold level in SCOP (as seen in the line 703) and then removing structural neighbors from the set if they shared the same SCOP family (as seen in the line 705), superfamily (as seen in the line 707) or fold (as seen in the line 709) classification as the query protein. Line 701 corresponds to the complete line in the legend. Line 703 corresponds to SCOP line in the legend. Line 705 corresponds to SCOP-family line in the legend. Line 707 corresponds to SCOP-superfamily line in the legend. Line 709 corresponds to SCOP-fold line in the legend.

The complete line 701 illustrated in FIG. 7A corresponds to structural neighbors 405 chosen from a 60% non-redundant (with respect to sequence) pool of ligand-containing proteins compiled as illustrated in the disclosed systems and methods. The “SCOP” line 703 illustrated in FIG. 7A corresponds to neighbors 405 chosen from the same pool, but required to have a SCOP annotation. The remaining lines 705, 707, 709 illustrated in FIG. 7A show z-scores when structural neighbors 405 are taken from the 60% non-redundant pool and specifically excluding proteins classified as belonging to the same SCOP family 705, superfamily 707 and fold 709 as the query protein 401 (proteins not classified in SCOP were also excluded).

FIG. 7B illustrates cumulative histograms of z-scores for proteins from the LigASite dataset, the orphan, and the unknown function protein set. In this example, no restrictions were introduced on the structural neighbors used. Line 711 corresponds to LigASite line in the legend. Line 713 corresponds to orphan protein set line in the legend. Line 715 corresponds to unknown function protein set line in the legend.

As illustrated in FIGS. 7A and 7B, nearly all proteins in the LigASite benchmark (90.2%) had more than 10 structural neighbors 405 when the complete pool was used, and most had z-scores more than 5 indicating significant conservation in the location of the binding site. Although a negative z-score was calculated for some query proteins, reflecting diversity in the geometric positions of ligand binding sites, the number of such proteins was small (11 or 7.53%). As illustrated in FIG. 7A and FIG. 7B, there can be conservation when proteins with shared SCOP annotations at different levels of the hierarchy are excluded.

Two additional sets of proteins, the orphan set and the unknown function set were also analyzed. Based on analysis, although it is unknown whether proteins in these two sets in fact bind a small molecule ligand, more than three-quarters of these proteins have z-scores above 5 (2B), similar to what was observed for proteins taken from the LigASite database. This degree of conservation indicates that for most ligand-binding query proteins there can be other structurally similar proteins that can bind their ligands in roughly the same geometric location and that it is reasonable to expect that an accurate binding-site prediction can be made for arbitrary query proteins.

To evaluate the performance of the disclosed systems and methods, the list of predicted interfacial residues for each query protein were sorted based on the disclosed systems and methods score and precision and recall were calculated for a number of residues corresponding to half the number of contacting residues in the actual binding site (for example, if a particular query protein has a binding site including of 10 residues, we calculate precision and recall for the top 5 predictions). It should be understood that Precision and recall are statistical measures of the quality of prediction.

In an example, the disclosed systems and methods achieve a precision of 0.8±0.3 and recall of 0.4±0.1 (perfect prediction would result in a precision of 1 and recall of 0.5). This performance compares favorably to that of ConCavity, which is one method of determining Lingand binding site prediction from protein sequence and structure. ConCavity uses the structure of the binding site and sequence conservation to make predictions, and achieves a precision of 0.7±0.3 and recall of 0.3±0.2. The performance of the disclosed systems and methods can be achieved by ensuring diversity in the set of ligands from structural neighbors by selecting redundant structural neighbors as long as their associated ligands were different (based on a Tanimoto similarity measure). It should be understood that in general this is not necessary and accurate predictions (for example, precision 0.7 and recall 0.3) can still be made if the pool of structural neighbors is clustered using, for example, a simple 60% sequence identity cutoff, regardless of ligand similarity. Also, although the performance is further diminished when close (for example more than 25% sequence identity) structural neighbors are excluded, reasonably accurate predictions can still be made.

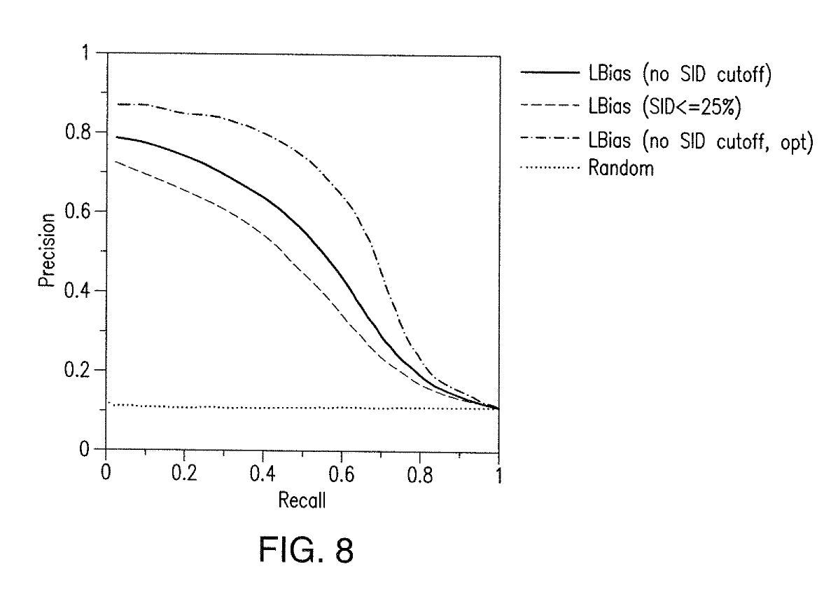

FIG. 8 illustrates an exemplary binding site prediction recall and precision in accordance with the disclosed systems and methods. FIG. 8 further illustrates the disclosed systems and methods performance for all cutoffs for the LigASite benchmark. As illustrated in FIG. 8, the lines represent recall and precisions values for binding site prediction averaged over all the proteins in the LigASite benchmark, where the different lines reflect different structural neighbor selection procedures.

In this example, these lines correspond to: selection from an optimized pool of structural neighbors (“opt,” dashed/dotted line); selection from 60% sequence non-redundant pool and no restriction on the sequence identity between a query protein and a given structural neighbor (“no SID cutoff,” solid line); and selection of neighbors from the 60% non-redundant pool further requiring that no neighbor have more than 25% sequence identity to the target Sequence Identity (SID) less than or equal to 25%, dashed line). In this example, the calculations were carried out for the set of proteins that had at least one structural neighbor in each of these pools (304 proteins for the standard LigASite benchmark, or 224 for the optimized set of structural neighbors). Holo proteins of a particular query protein were ignored in the analysis. In a similar manner to the approach described by Capra et al. precision and recall were plotted as follows. Surface residues were sorted according to their score based on the disclosed systems and methods.

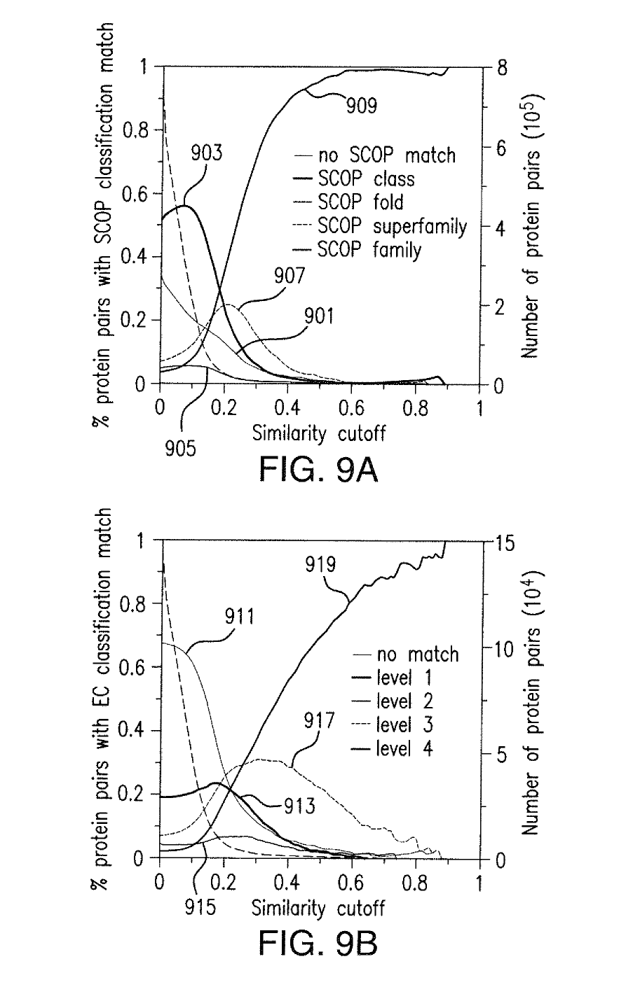

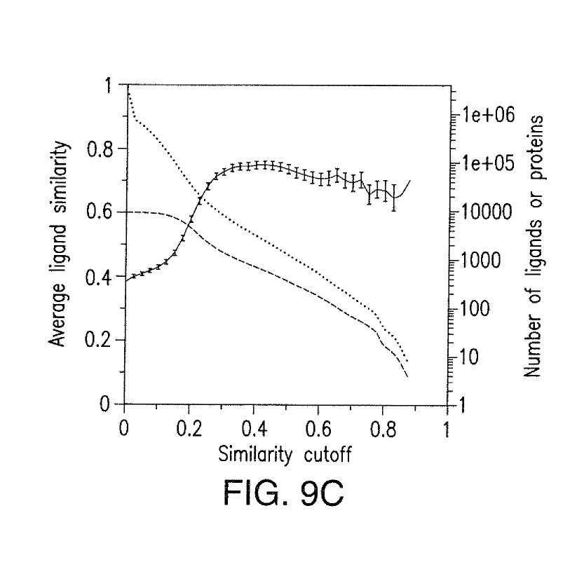

In this exemplary illustration, the sorted list of residues in each query protein were stepped through at 1% increments of the size of that protein. For example, for a query protein with 200 residues a precision and recall were calculated for the top, for example, 2, 4, 6, etc., residues in the list. This example generated a set of 100 precision and recall values for each query protein which were averaged over all query proteins to produce the curves illustrated in FIG. 9A, FIG. 9B, and FIG. 9C, Precision and recall are defined as:

$$precision = \frac{TP}{TP + PP} and recall = \frac{TP}{TP + PN} \qquad Equation ( 5 )$$

where TP stands for true positives, FP for false positive and FN for false negative. The definitions of true positive binding site residues were obtained from the LigASite database. In this exemplary illustration, random predictions were made for the precision and recall curves by randomizing the list of protein residues and assessing precision and recall values at fixed intervals.

FIG. 9A, FIG. 9B, and FIG. 9C illustrate exemplary correlation between binding site similarity and ligand shape in accordance with the disclosed systems and methods. The correlation is between binding site similarity as measured using the disclosed systems and methods (For example Sim(Q,N)) and ligand shape as measured by Tanimoto similarity for a set of protein pairs where both query and template contained a ligand.

In this exemplary illustration, the binding site similarity using the disclosed systems and methods was calculated for protein pairs where each protein in the pair contained a ligand. Starting from a binding site similarity (for example Sim(Q,N)) value of zero, a cutoff was applied at 0.01 increments and protein pairs for which the similarity was below the given cutoff were removed from the set.

As illustrated in FIG. 9A, FIG. 9B, and FIG. 9C, the weighted mean and standard deviation of ligand Tanimoto similarity (solid lines 901, 903, 905, 907, and 909) for all pairs of ligands where the binding site similarity between the proteins is above the cutoff on the x-axis. The dotted and dashed lines illustrated in FIG. 9A, FIG. 9B, and FIG. 9C are the number of ligands and proteins that went into the analysis, respectively. As illustrated in FIG. 9A, line 901 corresponds to the no SCOP match line in the legend. Line 903 corresponds to the SCOP class line in the legend. Line 905 corresponds to the SCOP fold line in the legend. Line 907 corresponds to the SCOP superfamily line in the legend. Line 909 corresponds to the no SCOP family line in the legend. As illustrated in FIG. 9B, line 911 corresponds to the no match line in the legend. Line 913 corresponds to the level 1 line in the legend. Line 915 corresponds to the level 2 line in the legend. Line 917 corresponds to the level 3 line in the legend. Line 919 corresponds to the level 4 line in the legend.

As illustrated in FIG. 9A, FIG. 9B, and FIG. 9C, a high binding site similarity correlates with high ligand similarity, but the relationship reaches a plateau, showing that diverse ligands can occupy the same site, consistent with conservation in the location of binding sites described above. It should be understood that at intermediate Sim(Q,N) (for example between 0.2 and 0.6), the ligand similarity can be close to that seen when Sim(Q,N) is high, indicating that a specific ligand could be inferred for one protein based on the ligand in the other. This can be supported by the fact that more than 60% of ˜24,000 pairs with Sim(Q,N) value of more than 0.2 share a SCOP classification at the superfamily or family level. Even when there is no obvious functional relationship, a Sim(Q,N) in this range can indicate at least partial similarity in ligand shape.

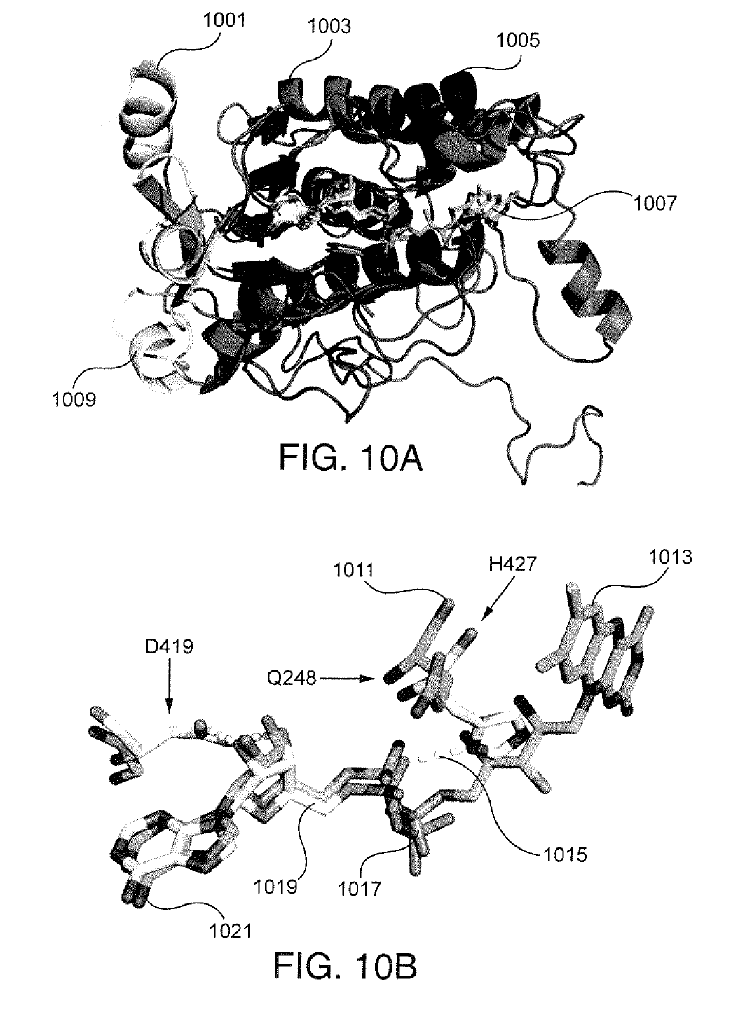

FIG. 10A and FIG. 10B illustrate an exemplary global binding site similarity between two proteins with a different SCOP fold classification but similar binding site. FIG. 10A and FIG. 10B illustrate two protein domains with Sim(Q,N)=0.5 that are classified in different SCOP folds. The sequence identity calculated from the structural alignment is in the twilight zone of sequence similarity (15.2%), but the coverage of d1hyua1 by d1djna3 in the structural alignment is at 67.5%. The sequence identity in the active site is much larger (48.2%) and there is, as evident from the figure, a clear relationship between the ligands in that the two ADP molecules overlap very closely with a heavy atom RMSD of 0.62.

FIG. 10A illustrates that NAD(P)-binding domain (SCOP domain d1hyua1 and fold classification c.3) is structurally superimposed on nucleotide-binding domain (SCOP domain d1djna3 and fold classification c.4), with their associated ligands shown in stick representation. As illustrated in FIG. 10A, 1001 represents the grey shaded portion. 1003 represents the red shaded portion. 1005 represents the blue shaded portion. 1007 represents the green shaded portion. 1009 represents the yellow shaded portion.

FIG. 10B illustrates close-up of the FAD molecule from d1hyua1 (1013 carbon atoms) and the ADP from d1djna3 (carbon atoms 1019). As illustrated in FIG. 10A and FIG. 10B, the two proteins share a large overlap of their secondary structure including the binding site (1021 and 1011 reference points). The secondary structural elements leading to a different fold classification are 1015 and 1021. As illustrated in FIG. 1013, 1011 represents the red shaded portion. 1013 represents the green shaded portion. 1015 represents the yellow shaded portion. 1017 represents the orange shaded portion. 1019 represents the grey shaded portion. 1021 represents the blue shaded portion.

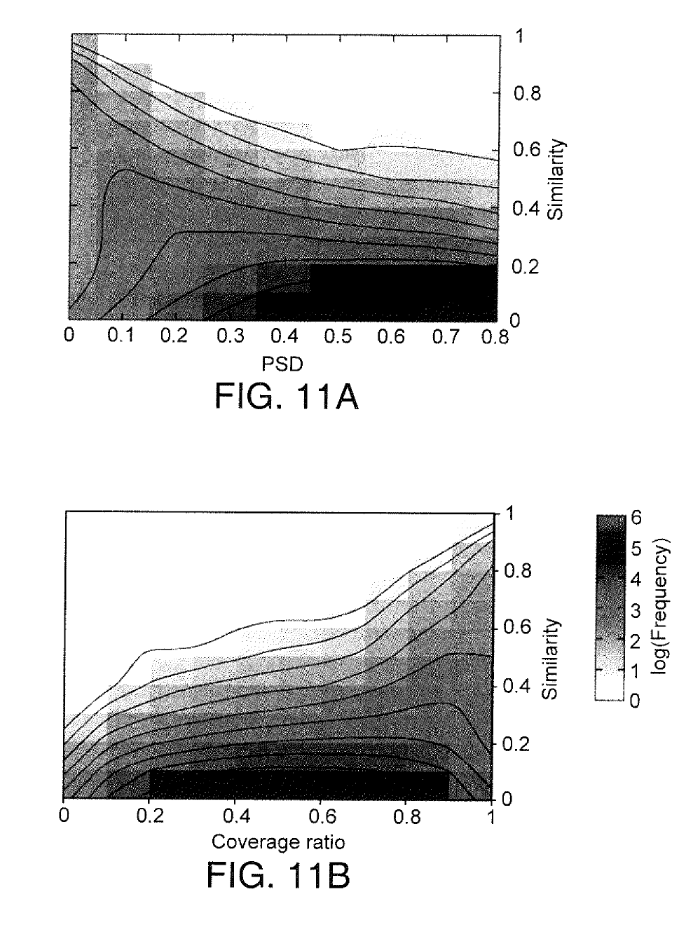

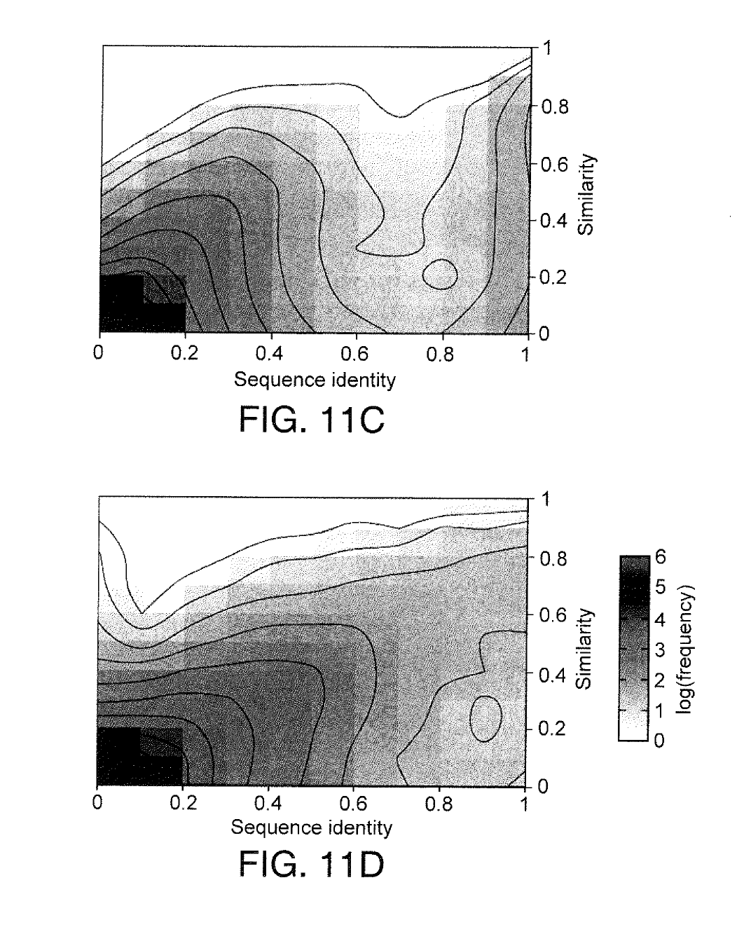

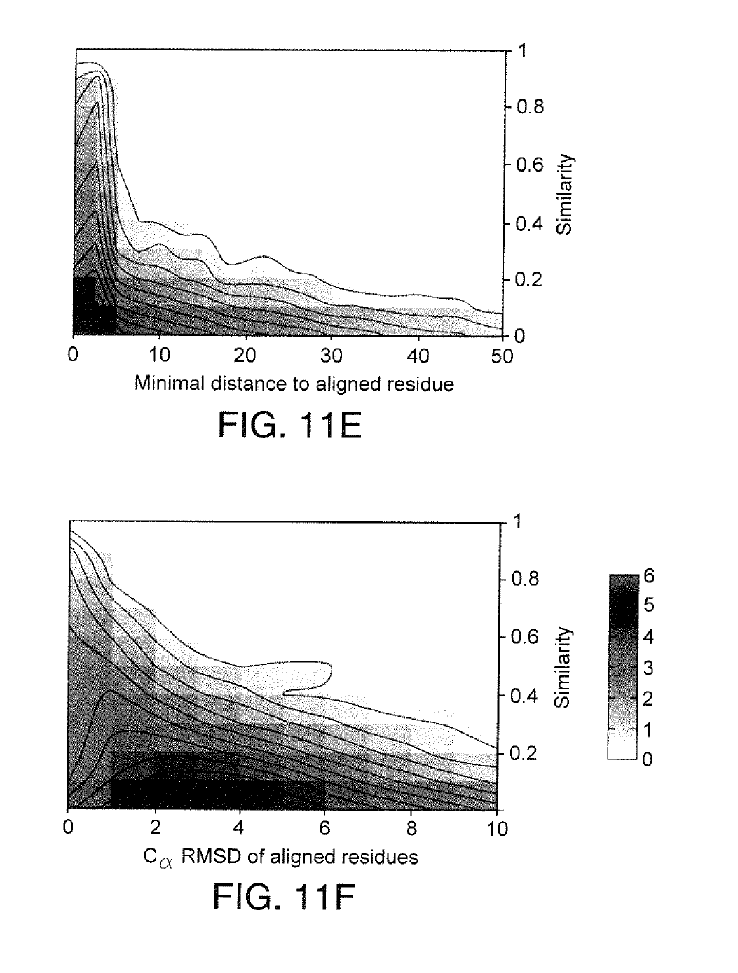

FIG. 11A, FIG. 11B, FIG. 11C, FIG. 11D, FIG. 11E, and FIG. 11F illustrate an exemplary dependence of binding site similarity with other measures of structural and sequence similarity. FIG. 11A, FIG. 11B, FIG. 11C, FIG. 11D, FIG. 11E, and FIG. 11F further illustrate the relationship between similarities in binding sites and other measures of global and local geometric/sequence similarity. FIG. 11A illustrates an overall structural similarity.

As further illustrated in FIG. 11A, protein pairs with a high binding site similarity are found predominantly in proteins with a matching overall structure and large coverage of the structural alignment. However, as further illustrated in FIG. 11A, proteins with an intermediate binding site similarity (which is likely to be useful for function annotation) are observed across the entire spectrum of geometric similarity. FIG. 11B illustrates coverage of structural alignment with respect to query protein. FIG. 11B further illustrates that even when the alignment only provides a partial match of the structure (i.e., when the two proteins are in different SCOP folds), a considerable number of protein pairs still have intermediate binding site similarity.

FIG. 11C illustrates global sequence identity derived from the structure-based sequence alignment using the query protein as reference. FIG. 11D illustrates local sequence identity computed from residues within 5 Å of ligand and structurally aligned residues. As further illustrated in FIG. 11C and FIG. 11D, protein pairs with low sequence identity both globally and in the binding site also frequently display an intermediate similarity.

FIG. 11E illustrates the minimal distance to any heavy atom of an aligned residue and FIG. 11F illustrates the Cα RMSD of the globally aligned residues in contact with the ligand (5 angstrom distance to any atom). FIG. 11E and FIG. 11F further illustrate shared local features are the dominant factors that lead to similar binding sites, highlighting the fact that proteins with different global topology can show very similar binding sites. The graph is shaded according to the logarithm of the frequency (log(Frequency+1)) protein pairs share a given property and binding site similarity.

The disclosed systems and methods can contain features that are unique to the interaction of proteins with small molecules. Specifically, structural alignment can be used to identify proteins that can potentially be used to identify ligands binding sites in a given query protein. However, the properties of the binding site can determine whether a relationship detected based on global topology is in fact meaningful. The effectiveness of the disclosed systems and methods can be attributed to a number of recent observations about the nature of protein structure space.

In a geometric sense, structure space can be complete at the domain level so that most proteins 401 are expected to have structural neighbors 403. The degree of conservation observed indicates that not only is protein structure space complete in terms of individual domains, but can be complete in terms in its ligand binding properties as well; that is, for any ligand-binding query protein there can be other structurally similar proteins that bind their ligands in roughly the same geometric location, similar to what has been observed for protein-protein interfaces.

There can be a continuous nature of protein structure space. That is, even if proteins have dissimilar global structures, many have partial similarities in substructures that can also indicate a functional relationship. The results of the disclosed systems and methods indicate that not only are the geometric locations of ligand binding sites conserved, but there is also a relationship between the ligands that bind to such sites (i.e., a similarity in some ligand moieties, as seen in FIG. 11A, FIG. 11B, FIG. 11C, FIG. 11D, FIG. 11E, and FIG. 11F) that is reflected in the binding site similarity score used in the disclosed systems and methods (i.e., similar moieties are bound by a similar configuration of chemical groups).

The detection of partial similarities can have uses in several important applications. In particular, the disclosed systems and methods can be useful in different aspects of drug design such as drug repurposing and the detection of side effects due to off-target binding. Both areas involve the binding of a drug molecule to a protein for which it was not intentionally designed. In the former, similar binding sites could be searched for with the disclosed systems and methods, indicating the potential novel use of a drug for another disease-related protein with a partially similar binding site. In the latter, drugs are often tested against closely related proteins to optimize specificity, but more distantly related proteins are often ignored in the initial analysis due to the vast number of potential proteins a potential drug would need to be tested against.

Approaches such as the disclosed systems and methods can therefore help in finding likely off-targets for a particular drug molecule early in the design process with a potential advantage lying in the broadness with which protein structure space is examined, compared with the classic approach in drug design which focuses more on nearest protein neighbors. Since the disclosed systems and methods do not depend on the detection of pockets, it can be applied in the search for protein-protein interface inhibitors which are more difficult to design than classic drug molecules that often bind to a well-defined pocket instead of a large solvent exposed surface patch of the protein.

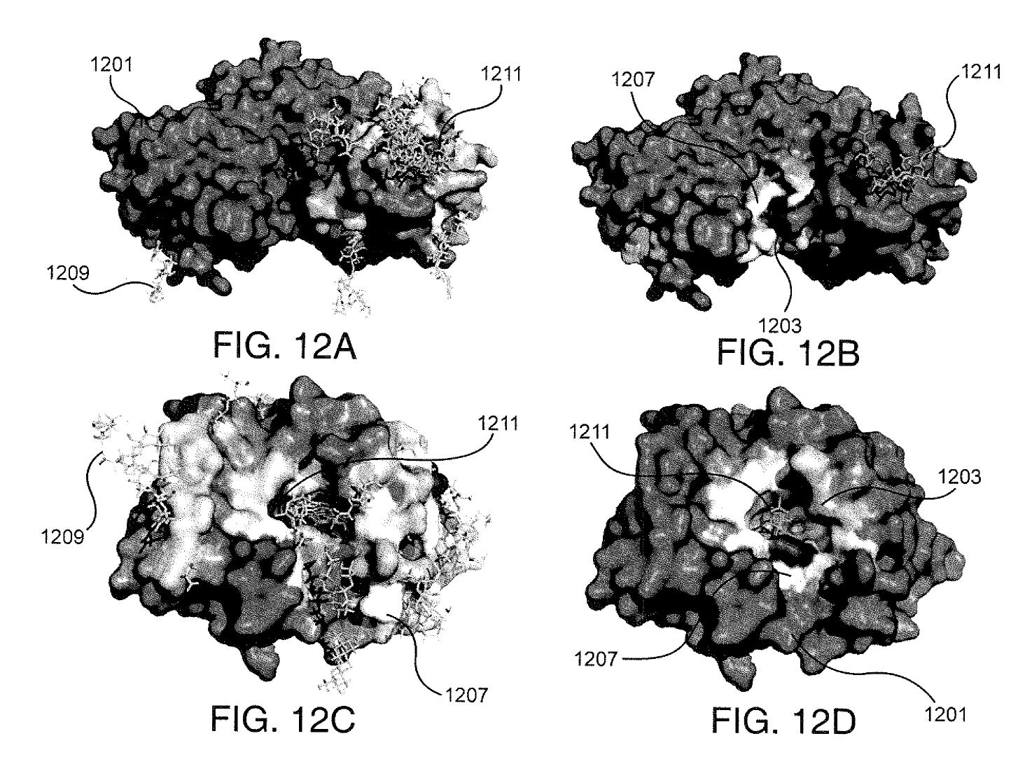

FIG. 12A, FIG. 12B, FIG. 12C, and FIG. 12D illustrate exemplary binding site prediction. FIG. 12A, FIG. 12B, FIG. 12C, and FIG. 12D illustrate two examples that highlight important differences between the template-based approaches like the disclosed systems and methods and approaches that use only the surface properties of the query. FIG. 12A illustrates Botulinum neurotoxin serotype A binding protein was co-crystallized with a ligand consisting of multiple sugar units (PDB code: 2VU9) which bind in a shallow groove whose location is conserved in the set of structural neighbors.

FIG. 12B illustrates that ConCavity identifies a small pocket that does not represent the true binding site. On the other hand, the disclosed systems and methods can achieve a precision of 1 and recall of 0.471 based on ligands retrieved from structural neighbors and is independent of the shallowness of the binding site. FIG. 12C illustrates a genuine diversity in the location of binding sites in the set of structural neighbors of a given query protein (PDB code: 1AHC). FIG. 12D illustrates that ConCavity with conservation can correctly predict a well-defined cavity as the binding site.

Despite the diversity in ligand positions among the structural neighbors 403, however, the disclosed systems and methods with its incorporation of binding site similarity can successfully focus on ligands in positions structurally equivalent to the correct site, resulting in a successful prediction (0.875 precision and 0.412 recall). Moreover, the binding site score for a single structural neighbor (0.70 for the template 1HWP) is within the range that is typically associated with functional similarity and indeed this template shares the same EC classification. FIG. 12A and FIG. 12B further illustrate the native ligands from the holo structures of botulinum neurotoxin. FIG. 12C and FIG. 12D further illustrate α-momorcharin (shown by reference 1211).

In FIG. 12A, FIG. 12B, FIG. 12C, and FIG. 12D, surfaces on the left of the figure are shaded according to the ligand binding contact frequency and those on the right according to the ConCavity with conservation score (lowest 1201, intermediate 1207 and highest score 1203). Transformed ligands from structural neighbors in panels A and C are shown by reference 1209. FIG. 12A, FIG. 12B, FIG. 12C, and FIG. 12D illustrate that the disclosed systems and methods offers a successful approach that avoids the drawbacks of either cavity-detection or template-based methods. More generally, the strategy of considering a wide range of hypotheses for function annotation and integrating different sources of functional and structural information to generate a prediction represents the fundamental idea of our annotation server MarkUs, to which the disclosed systems and methods can be added.

Although, in the examples, the data of FIG. 10A and FIG. 10B and FIG. 12A, FIG. 1213, FIG. 12C, and FIG. 12D were produced from the global alignment of the query protein with each structural neighbor, a similar global picture was observed when binding sites were realigned using only Cα-atoms within 8 Å distance of the ligand (average ΔSim(A,B)=0.016±0.087). It should be understood that realignment of binding sites can occur (at least three globally aligned Cα-atoms) for 4.6*10⁵ of the one million protein pairs described before.

The disclosed subject matter can be implemented in hardware or software, or a combination of both. Any of the methods described herein can be performed using software including computer-executable instructions stored on one or more computer-readable media (e.g., communication media, storage media, tangible media, or the like). Furthermore, any intermediate or final results of the disclosed methods can be stored on one or more computer-readable media. Any such software can be executed on a single computer, on a networked computer (for example, via the Internet, a wide-area network, a local-area network, a client-server network, or other such network), a set of computers, a grid, or the like. It should be understood that the disclosed technology is not limited to any specific computer language, program, or computer. For instance, a wide variety of commercially available computer languages, programs, and computers can be used.

A number of embodiments of the disclosed subject matter have been described. Nevertheless, it will be understood that various modifications may be made without departing from the spirit and scope of the disclosed subject matter. Accordingly, other embodiments are within the scope of the claims.

We claim:

1. A method for predicting protein-ligand interactions for one or more query proteins, comprising:
identifying, using a computer, a set of one or more structural neighbours of the one or more query proteins, wherein each of the one or more structural neighbours contains one or more ligands;
determining, using a computer, a similarity score for each of the one or more structural neighbours representing configuration similarity between one or more atoms of the one or more query proteins and one or more atoms of the one or more structural neighbours; and
predicting protein-ligand interactions of the one or more query proteins using the similarity scores.

2. The method of claim 1, wherein the one or more structural neighbours are obtained from a database containing one or more ligands associated protein chains and ligand-binding residues of one or more proteins.

3. The method of claim 2, wherein the database contains at least one structure of the one or more proteins in its holo form.

4. The method of claim 2, wherein the database contains at least one structure of the one or more proteins in its apo form.

5. The method of claim 1, wherein the determining further comprises:
for each of the one or more query proteins:
placing one or more ligands from the set of one or more structural neighbours in a coordinate system using a transformation that relates the one or more structural neighbours to the one or more query proteins to thereby determine one or more transformed ligands;
determining whether the one or more transformed ligands is within a predetermined distance of a surface residue of the one or more query proteins;
incrementing a counter associated with the residue if the one or more transformed ligands is within a predetermined distance of the surface residue of the one or more query proteins; and
determining the similarity score using the counter.

6. The method of claim 5, wherein the surface residue comprises greater than a predetermined solvent accessible surface area.

7. The method of claim 5 further comprising:
identifying interactions between the one or more ligands of the one or more structural neighbours and the corresponding one or more structural neighbours; and
identifying interactions the one or more transformed ligands makes in the coordinate system of the one or more query proteins.

8. The method of claim 2, further comprising optimizing the database comprising one or more ligands associated protein chains, comprising:
determining a reference set of one or more ligands associated protein chains from the database;
identifying a chain to which the one or more ligands are bound by using a predetermined distance cutoff; and
clustering the one or more ligands associated protein chains into one or more non-redundant groups based on the predetermined distance cutoff.

9. The method of claim 8, further comprising:
for each of the one or more non-redundant groups:
sorting the one or more ligands associated protein chains based on classification and fold level;
discarding the one or more ligands associated protein chains that have a sequence identity more than a predetermined percentage value to other one or more structural neighbours.

10. A computer-readable storage media having encoded therein instructions to predict protein-ligand interactions for one or more query proteins which, when executed by a computer, cause the computer to:
identify, using a computer, a set of one or more structural neighbours of the one or more query proteins, wherein each of the one or more structural neighbours contains one or more ligands;
determine, using a computer, a similarity score for each of the one or more structural neighbours representing configuration similarity between one or more atoms of the one or more query proteins and one or more atoms of the one or more structural neighbours; and
predict protein-ligand interactions of the one or more query proteins using the similarity scores.

11. The computer-readable storage media of claim 10, wherein the determining further comprises:
for each of the one or more query proteins:
placing one or more ligands from the set of one or more structural neighbours in a coordinate system using a transformation that relates the one or more structural neighbours to the one or more query proteins to thereby determine one or more transformed ligands;
determining whether the one or more transformed ligands is within a predetermined distance of a surface residue of the one or more query proteins;
incrementing a counter associated with the residue if the one or more transformed ligands is within a predetermined distance of the surface residue of the one or more query proteins; and
determining the similarity score using the counter.

12. The computer-readable storage media of claim 11 further comprising:
identifying interactions between the one or more ligands of the one or more structural neighbours and the corresponding one or more structural neighbours; and
identifying interactions the one or more transformed ligands makes in the coordinate system of the one or more query proteins.

13. A system for predicting protein-ligand interactions for one or more query proteins, the system comprising:
a computer, the computer comprising:
a database comprising a set of one or more structural neighbours of the one or more query proteins;
an input component for receiving the set of one or more structural neighbours of the one or more query proteins;
the input component further configured to receive the one or more query proteins;
a processor for generating a similarity score for each of the one or more structural neighbours, using a computer, representing configuration similarity and interaction tendency between one or more atoms in a first member of each of one or more structural neighbours; and
an output component comprising one or more hardware displays, to provide a prediction of the protein-ligand interactions of the one or more query proteins using the similarity score for each of the one or more structural neighbours.

14. The system of claim 13, wherein the one or more structural neighbours are obtained from a database containing one or more ligands associated protein chains and ligand-binding residues of one or more proteins.

15. The system of claim 14, wherein the database contains at least one structure of the one or more proteins in its hobo form.

16. The system of claim 14, wherein the database contains at least one structure of the one or more proteins in its apo form.

17. The system of claim 13, wherein the determining further comprises:
for each of the one or more query proteins:
placing one or more ligands from the set of one or more structural neighbours in a coordinate system using a transformation that relates the one or more structural neighbours to the one or more query proteins to thereby determine one or more transformed ligands;
determining whether the one or more transformed ligands is within a predetermined distance of a surface residue of the one or more query proteins;
incrementing a counter associated with the residue if the one or more transformed ligands is within a predetermined distance of the surface residue of the one or more query proteins; and
determining the similarity score using the counter.

18. The system of claim 17, wherein the surface residue comprises greater than a predetermined solvent accessible surface area.

19. The system of claim 17 further comprising:
identifying interactions between the one or more ligands of the one or more structural neighbours and the corresponding one or more structural neighbours; and
identifying interactions the one or more transformed ligands makes in the coordinate system of the one or more query proteins.

20. The system of claim 14, further comprising optimizing the database comprising one or more ligands associated protein chains, comprising:
determining a reference set of one or more ligands associated protein chains from the database;
identifying a chain to which the one or more ligands are bound by using a predetermined distance cutoff; and
clustering the one or more ligands associated protein chains into one or more non-redundant groups based on the predetermined distance cutoff.
